(19) United States
(12) Patent Application Publication
(10) Pub. No.: US 2020/0309805 A1
(43) Pub. Date: Oct. 1, 2020

(54) METHOD FOR MEASURING ANGULAR SPEEDS, ASSOCIATED DEVICE AND SENSOR

(71) Applicant: PIQ, NEUILLY-SUR-SEINE (FR)

(72) Inventors: Fernando ROMAO, PARIS (FR); Andrei SHELEH, MINSK (BY)

(21) Appl. No.: 16/089,970

(22) PCT Filed: Mar. 28, 2017
(86) PCT No.: PCT/FR2017/050705

§ 371 Date: Sep. 28, 2018

(30) Foreign Application Priority Data
Mar. 30, 2016 (FR) 1652733

(51) Int. Cl. G01P 3/00; G06K 9/00; G01P 21/00; G01C 19/00; A63F 13/211

(52) U.S. Cl. CPC G01P 3/00; G06K 9/00496; A63F 13/211; G01C 19/00; G01P 21/00

(57) ABSTRACT

Method and associated device for estimating a series of angular speeds ωₙ at successive instants tₙ, including a first step (E1) of measuring an angular speed in a domain of values below a saturation threshold 107 ₁ₛ; a second step (E2; E3) of measuring a linear acceleration γ; a second step (E2; E3) of measuring a linear acceleration γ; a step (E4) of detecting a saturation state during the first measurement step (E1); a calculation step (E5) for estimating, in case of detection of a measurement saturation during the first measurement step, the angular speed at each instant tₙ as a function of at least the acceleration value γ measured at the instant tₙ and of the angular speed value obtained at an earlier instant t₁₋₁, at least one first measurement of the angular speed below the saturation threshold having been obtained.

The present invention concerns the field of the processing signals and the merging of data in multisport data sensors configured for the evaluation of sporting performance in different disciplines, such as golf, tennis or skiing.

The invention more particularly relates to the measurement of rotation speeds of sports accessories. It is particularly applicable to the field of golf, in which there is a real need to conduct an in-depth analysis of the swing movement of a golfer for a better understanding of his game in order to improve his performance. It is thus necessary to measure the instantaneous rotation speed of the head of a golf club during the golfer's swing movement to better characterize that movement.

There are existing multisport sensors configured to be fastened to the golfer's glove and capable of measuring, in particular, the acceleration and the speed of the golfer's glove in action while he performs a swing movement.

However, such sensors do not enable sufficiently reliable and accurate determination of high angular speeds and in particular the maximum rotational speed of the golf club head during the swing movement.

As a matter of fact, this type of very fast movement is characterized by high accelerations the measurement of which is not always reliable.

The present invention is directed to solving the aforementioned drawbacks, by providing a device and a method for accurately and reliably evaluating, in real time, an instantaneous angular speed.

The present invention makes it possible to estimate an instantaneous angular speed, in particular a maximum angular speed, beyond a saturation threshold, starting from which the conventional angular speed measurement means enter into a saturation regime.

To that end, the device and the method according to the invention exploit the measurement of non-saturated instantaneous linear acceleration data, to estimate an instantaneous angular speed, when the measurement of the latter is saturated. This estimation also makes use of instantaneous angular speed values obtained at earlier instants, these values being measured before reaching the saturation threshold or being estimated further to at least one preceding iteration of the estimation method.

Thus, the present invention advantageously makes it possible to estimate, at each instant, the instantaneous angular speed, beyond limitations inherent to the means for measuring the angular speed and in particular to estimate a maximum angular speed which cannot be measured by conventional angular speed measuring means.

Naturally, to satisfy specific needs, a person competent in the technical field will be able to apply modifications to the following description. Although it refers to different embodiments, the present invention is not limited to those specific embodiments, and any modification suitable to the field of application of the present invention can be considered as obvious for a person knowledgeable in the art of the corresponding technical art.

The invention concerns a method for estimating a series of angular speeds ωₙ at successive instants tₙ, comprising a first step of measuring an angular speed in a range of values below a saturation threshold ω₁ₛ, a second step of measuring a linear acceleration γ, a step of detecting a state of saturation at the first measuring step, and a computing step to estimate, in case of detection of measurement saturation at the first measuring step, the angular speed ω(n), at each instant tₙ, according to at least one value of the acceleration measured at the instant tₙ and according to at least one value of angular speed obtained at an earlier instant tₙ₋₁, at least one first measurement of the angular speed below the saturation threshold ω₁ₛ having been obtained.

The values of linear acceleration measured in real-time, in a non-saturated measuring regime, advantageously make it possible to estimate the angular speed, in case of saturation of measurements obtained at the first measuring step. The use of these linear acceleration data advantageously makes it possible to improve the reliability of the estimation relative to a method of pure extrapolation.

According to a particular embodiment of the invention, the angular speed ω(n) estimated at the instant tₙ is obtained by adding the value of the angular speed ω(n−1) obtained at the preceding instant tₙ₋₁ to a component of angular speed A(n) obtained at the instant tₙ by conversion of the value of linear acceleration (γ₂(n); γ₃(n)) measured in a non-saturated regime at that same instant tₙ, by applying a predetermined conversion coefficient.

The angular speed ω(n) estimated at the instant tₙ is obtained by adding, to the value of the angular speed ω(n−1) obtained at the preceding instant tₙ₋₁, a differential Δ(n) at the instant tₙ of which the value is obtained by conversion of a difference between two values of angular speed obtained at two consecutive earlier instants tₙ₋₂, tₙ₋₁, by applying a predetermined attenuation coefficient.

The application of an attenuation coefficient is particularly advantageous to limit the value of the differential Δ and thereby reduce the increase in the resulting value of angular speed.

The at least one of the conversion and attenuation coefficients is obtained in advance by a method of statistical analysis.

The use of a method of statistical analysis to determine the value of the conversion coefficient and/or that of the attenuation coefficient is particularly advantageous to obtain a coefficient value that is reliable by taking into account a sufficiently wide diversity of cases.

According to another embodiment of the invention, the computing step includes a sub-step of evaluating a radius R of a path of a rotational movement, according to the value of linear acceleration and the value of angular speed measured ω₁(n−1) or estimated ω(n−1) further to a preceding iteration of the computing step, and in that the value of angular speed ω(n) at the instant tₙ is computed according to the value of the radius R obtained at the preceding instant tₙ₋₁.

At the time of a rotational movement, the radius of a circular path is determined, at each instant, in particular according to real data that are measured. This advantageously makes it possible to improve the reliability of the computation of the value of the radius, in particular if the radius is not constant, for example during the execution of a swing movement in the case of the practice of golf. The value of the radius is thereby determined automatically and in real time, at the computing step.

According to an example embodiment of the invention, the value of the radius R is computed at the instant tₙ according to the following expression:

$${R}_{( n )} = \frac{{γ}_{( n )}}{\sqrt{{\dot{ω}}^{2} ( n ) + {ω}^{4} ( n )}}$$

in which γ(n), ω(n) and \dot{ω}(n) respectively designate the linear acceleration, the angular speed and the angular acceleration, at the instant tₙ.

This expression for the radius assumes a rotational movement around a fixed rotational axis. This assumption is particularly appropriate in the case of the practice of golf, to describe the movement of a golf club, in a swing movement.

Furthermore, this expression ensures a good compromise between the level of complexity of the computation implemented and the reliability of the result obtained. The computation of this expression may thereby be carried out in real time, at a sampling frequency supported by most computing units currently available on the market.

According to a variant embodiment of the invention, the angular speed estimated at the instant tₙ is computed according to the following expression:

$${ω}_{( n )} = {( \frac{{γ}_{( n )}^{2}}{{R}_{( n - 1 )}^{2}} - {\dot{ω}}_{( n - 1 )}^{2} )}^{1 / 4}$$

in which γ(n) designates the linear acceleration measured at the instant tₙ, R(n−1) designates the radius computed at the preceding instant tₙ₋₁, and \dot{ω}(n) designates the angular speed obtained at the instant tₙ.

The angular speed is estimated, at each instant, according to the value of instantaneous acceleration measured in a non-saturated regime and according to the radius computed at the preceding instant.

This expression used to estimate the instantaneous angular speed assumes that the values of angular acceleration measured or estimated at the two consecutive instants tₙ and tₙ₋₁ are substantially equal and that the values of the radius measured or estimated at the two consecutive instants tₙ and tₙ₋₁ are substantially equal. Such assumptions are appropriate in particular in the case of the swing movement of a golfer.

Furthermore, this expression makes it possible to ensure good reliability in the estimation of the angular speed at each instant, by considering conventional sampling and computing frequencies implemented in most components currently on the market.

According to another variant embodiment of the invention, the value of angular speed ω(n) estimated at the instant tₙ is computed by solving the following equation:

$${ω}_{( n )}^{4} + \frac{{ω}_{( n )}^{2}}{{T}^{2}} - 2 \frac{{ω}_{( n - 1 )}}{{T}^{2}} {ω}_{( n )} - \frac{{γ}_{( n )}^{2}}{{R}_{( n - 1 )}^{2}} + \frac{{ω}_{( n - 1 )}^{2}}{{T}^{2}} = 0 ,$$

T designating a reference time interval between two consecutive instants.

The value of angular speed estimated at each instant tₙ is a solution of the 4^{th} order polynomial of which the coefficients are determined according to the value of instantaneous acceleration measured in non-saturated regime and according to a radius value and an angular speed value which are estimated or measured at the earlier instant tₙ₋₁.

According to another variant embodiment of the invention, the value of angular speed ω(n) is computed according to the following expression:

$$ω ( n ) = ω ( n - 1 ) \pm T . \frac{γ ( n )}{R ( n - 1 )}$$

Thus, the angular speed ω(n) at each instant tₙ is computed according to the value of the angular speed ω(n−1) measured or computed at an earlier instant, in particular at the preceding instant tₙ₋₁, and according to the value of the radius R computed at that same preceding instant tₙ₋₁, and according to the value of the instantaneous linear acceleration γ(n) measured at the instant tₙ in a non-saturated regime.

According to an example embodiment of the invention, the value of linear acceleration γ is obtained with a second accelerometer, in case of saturation of a first accelerometer configured to measure the linear acceleration. In this case, the method according to the invention further comprises a calibrating step for calibrating the second accelerometer according to the values of acceleration measured by the first accelerometer before saturation.

The invention is also directed to a device for estimating a series of angular speeds ωₙ at successive instants tₙ, the device comprising first measuring means configured to measure an angular speed ω₁ in a range of values below a saturation threshold ω₁ₛ, second measuring means configured to measure a linear acceleration γ, means for detecting a state of saturation of the first measuring means, computing means configured to estimate, in case of detection of a saturation of said first measuring means, said angular speed ω(n) at each instant tₙ according to at least one value of linear acceleration γ(n) measured at the instant tₙ, and according to the value of angular speed obtained at an earlier instant tₙ₋₁, at least one first measurement of the angular speed below the saturation threshold ω₁ₛ having been obtained.

As soon as the measurement of the angular speed enters saturated regime, in other words when the value of that speed reaches the predetermined measurement threshold, the values of angular speed are no longer reliable.

The second measuring means make it possible to mitigate the limitations of measurement of the first measuring means, by providing linear acceleration data measured in real time and in a non-saturated measuring regime. The taking into account of these measured data to estimate the angular speed in case of saturation of said first measuring means advantageously makes it possible to improve the reliability of the estimation relative to a method of pure extrapolation.

In an example embodiment of the invention, the first measuring means comprise a gyrometer or a gyroscope and the second measuring means comprise at least one linear accelerometer.

Advantageously, the second measuring means comprise a first accelerometer and a second accelerometer having a saturation threshold γ₃ₛ above that γ₂ₛ of the first accelerometer, and in that said computing means are configured to obtain the value of linear acceleration γ₃(n) measured with the second accelerometer in case of saturation of the first accelerometer.

The use of a second accelerometer having the advantage of a measurement range or dynamic above that of the first accelerometer is advantageous in case of saturation of the first accelerometer to continue in real time to provide linear acceleration data required for the estimation of the angular speed.

According to a variant embodiment of the invention, the device further comprises calibration means configured to calibrate the second accelerometer according to a set of acceleration values measured by the first accelerometer in a non-saturated measuring regime.

If the first accelerometer has a greater measurement accuracy than that of the second accelerometer, the calibration means advantageously make it possible to improve the reliability of the measurement of the acceleration data and therefore estimate the angular speed with an increased reliability.

According to a particular example embodiment of the invention, the second accelerometer is configured to measure the acceleration at a cadence at least 2 times greater than that of the first accelerometer.

The fact that the second accelerometer has a measurement cadence, in particular a sampling frequency, higher than that of the first accelerometer is particularly advantageous to reliably identify the maximum value of the estimated angular speed.

The invention is also directed to a data sensor comprising the device according to one or more of the specificities described above.

A data sensor, for example of multisport type, equipped with such a device is particularly advantageous to estimate, at each instant, and with high reliability and accuracy, the angular speed of accessories associated with the sensor. Such a sensor may be used in particular to measure high angular velocities and in particular the maximum rotational speed of the head of a golf club.

In a particular embodiment of the invention, steps of the aforementioned method are determined by instructions of computer programs.

Therefore, the invention is also directed to a computer program on a data carrier, that program being capable of being implemented by a microprocessor, that program comprising instructions configured for the implementation of the steps of the method as mentioned above.

This program may use any programming language, and be in any form of source code, object code, or code intermediate between source code and object code, such as in a partially compiled form, or in any other desirable form.

The invention is also directed to a data carrier readable by a microprocessor and comprising instructions of a computer program as mentioned above.

The data carrier may be any entity or device capable of storing the program. For example, the carrier may comprise a storage means, such as a memory of ROM (Read Only Memory) type, for example a microcircuit ROM, a magnetic recording means, for example a hard disk, or a flash memory.

Moreover, the data carrier can be a transmissible medium such as an electrical or optical signal, which can be conveyed via an electrical or optical cable, or else by radio or by other means. A program according to the invention may in particular be downloaded onto a storage platform of a network of Internet type.

Alternatively, the information carrier may be an integrated circuit in which the program is incorporated, the circuit being configured to execute or be used in the execution of the method in question.

The aforementioned data carrier and computer program have features and advantages that are similar to the methods they implement.

Still other particularities and advantages of the invention will appear in the following description, in relation with the accompanying drawings which are given by way of non-limiting examples, and in which:

FIG. 1 is a diagrammatic illustration of a device for measuring an angular speed according to a particular embodiment of the invention;

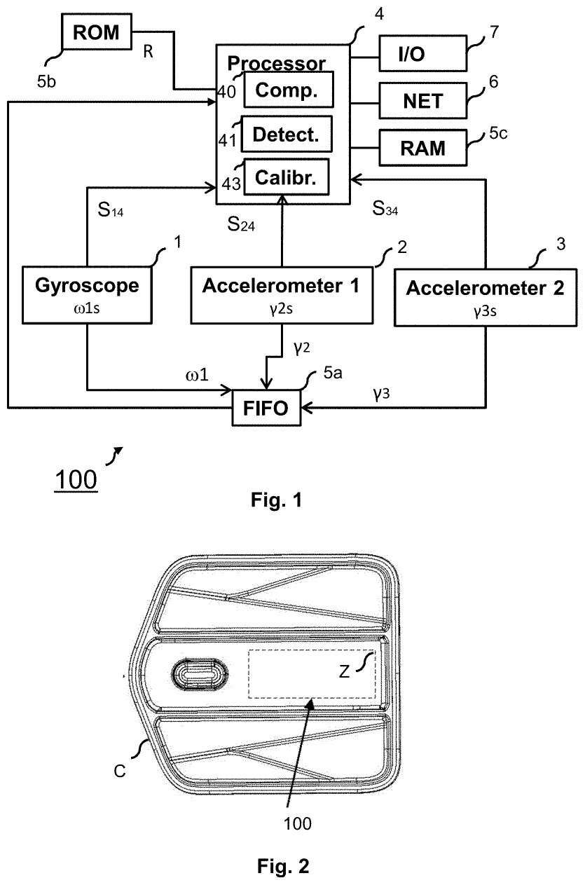

FIG. 2, illustrates a multisport data sensor incorporating the device according to the invention;

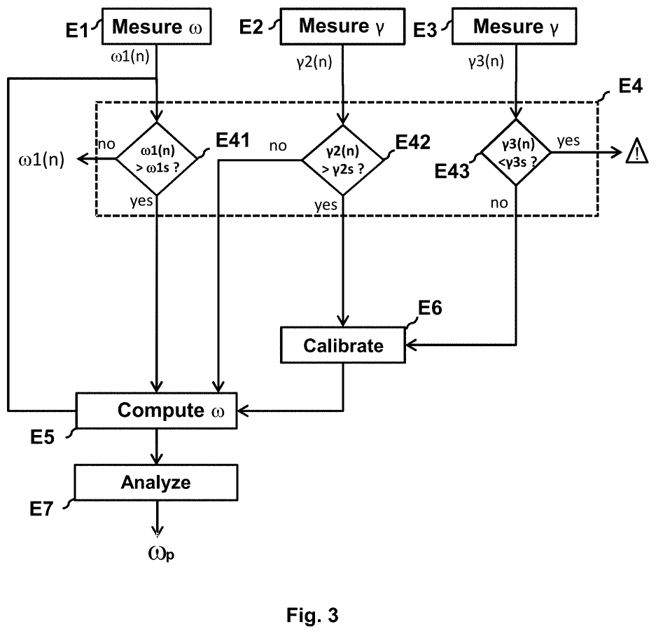

FIG. 3 illustrates the main steps of the method according to an example embodiment of the invention to measure a maximum angular speed;

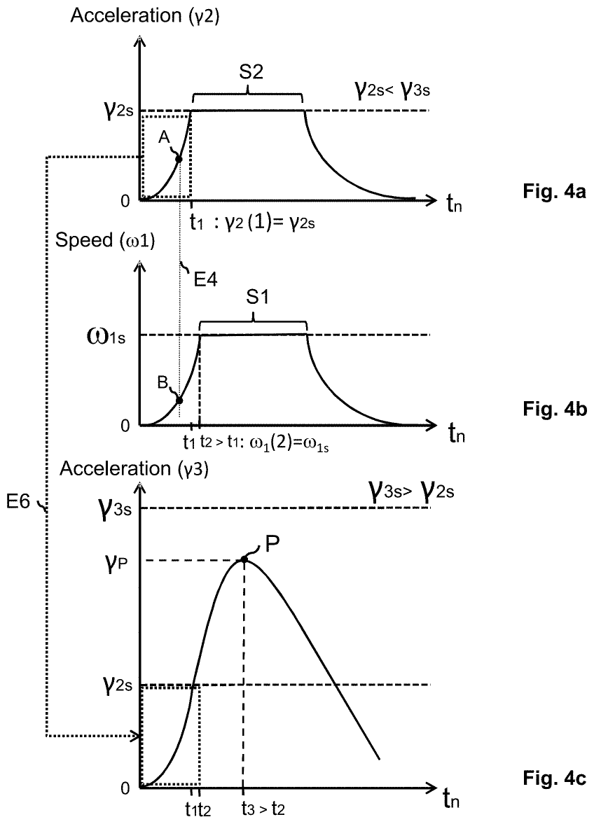

FIGS. 4a, 4b, 4c illustrate timing diagrams of quantities measured by the device according to the invention;

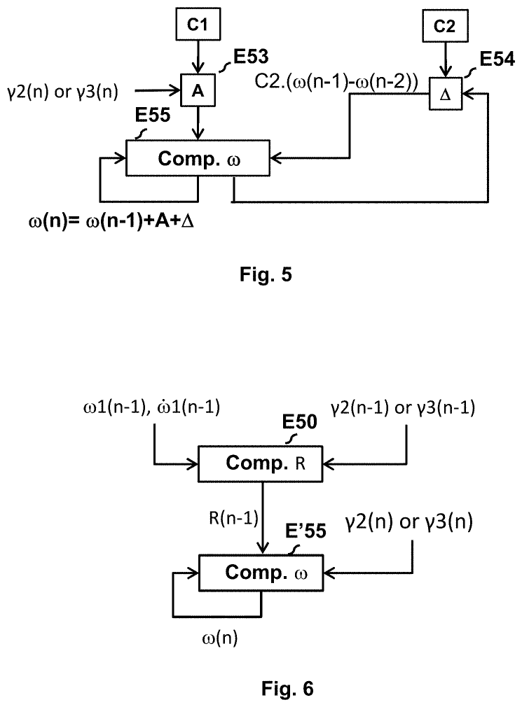

FIG. 5 illustrates the main computing steps to estimate the angular speed according to a first embodiment of the invention;

FIG. 6 illustrates the main computing steps to estimate the angular speed according to a second embodiment of the invention;

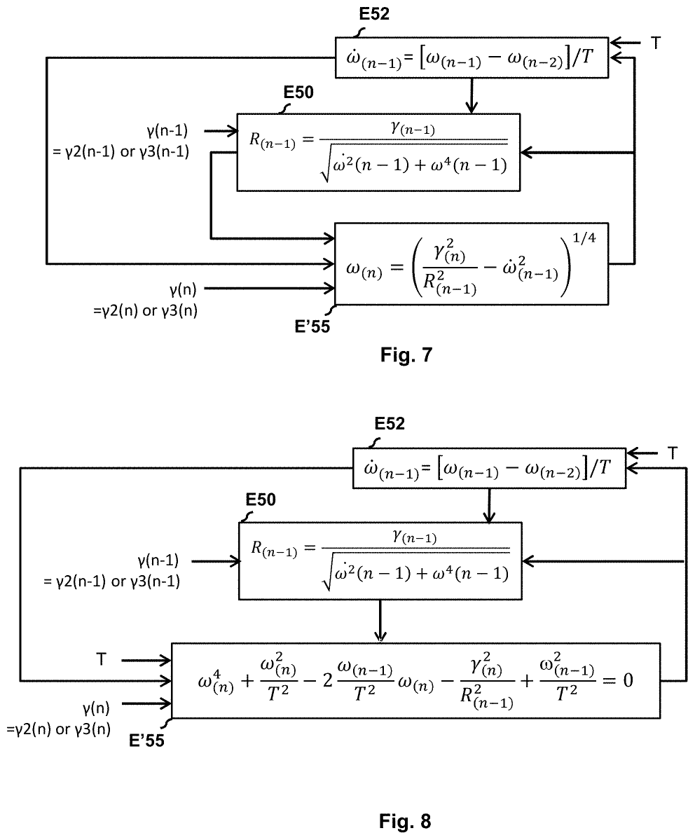

FIG. 7 illustrates computing sub-steps to estimate the angular speed according to a first variant of the second embodiment of the invention;

FIG. 8 illustrates computing sub-steps to estimate the angular speed according to a second variant of the second embodiment of the invention.

FIG. 1 represents, by way of example and diagrammatically, a device 100 for estimating a high angular speed with reliability and accuracy and in particular a maximum angular speed, according to a particular embodiment of the invention.

Generally, high speed means a speed greater than a predetermined saturation threshold, starting from which the associated measuring means supply a speed value equal to said threshold. In this case, the measuring means are in a state of saturation or operation in a saturated measuring regime referred to as saturation regime.

The device according to the invention 100 comprises first measuring means 1 configured to measure an instantaneous angular speed ω, in a range of values below or equal to a first measurement threshold ω₁ₛ. The first measuring means 1 enter a saturation regime, as soon as the measured value reaches said first threshold ω₁ₛ. In this case, the measurement obtained in this saturation regime is said to be “saturated”.

By way of illustrative and non-limiting example, the first measuring means are constituted by a gyroscope 1 configured to measure the instantaneous angular speed ω with a saturation threshold set at 2000°/s, in which the symbol ° designates the degree, such that 1°=π/180 Radians (Rad). In particular, the gyroscope 1 is a three-axis gyroscope capable of measuring the components of the angular speed ω in three orthogonal directions. To optimize the accuracy of the measurements provided, it will be possible, for example, to configure a gyroscope limited to 4000°/s to operate up to a saturation threshold equal to 2000°/s.

To increase the accuracy of the measurements provided with a gyroscope having a relatively low analog/digital conversion resolution (e.g. 16 bits), the scale factor of the gyroscope 1 is initially adjusted to 1000°/s, so as to apply the same resolution on a lower scale, thereby reducing the quantization step size. In this configuration, the gyroscope 1 reaches the saturation threshold without having had the time to reconfigure the scale factor, which is advantageous in a longer term.

The gyroscope 1 may also measure the instantaneous angular acceleration \dot{ω}(t)=dω/dt. If the latter is not configured to measure the angular acceleration, this could be estimated in real time, according to values of instantaneous angular speed measured by the gyroscope 1.

The device according to the invention 100 further comprises second measuring means configured to measure an instantaneous linear acceleration γ, these second means comprising at least one linear accelerometer.

In the present embodiment, the second measuring means comprise a first accelerometer 2 and a second accelerometer 3. The first accelerometer 2 is configured to measure the instantaneous linear acceleration γ in a range of values below or equal to a second saturation threshold γ₂ₛ. The second accelerometer 3 is configured to measure this same acceleration γ in a range of values below or equal to a third saturation threshold γ₃ₛ, such that this third saturation threshold is above that γ₂ₛ of the first accelerometer 2: γ₃ₛ>γ₂ₛ.

By way of illustrative example, the first accelerometer 2 is a three-axis accelerometer, able to measure the instantaneous linear acceleration γ in three orthogonal directions. For each of its three axes, it has a low measurement dynamic limited by a low saturation threshold, for example equal to 16 g (γ₂ₛ=16 g), in which g designates the acceleration due to gravity at the surface of the earth which is equal to 9.80665 m·s⁻². This accelerometer 2 comprises analog/digital conversion means configured for sampling the measurements at a sampling frequency set at 100 Hz.

By way of illustrative non-limiting example, the second accelerometer 3 is a three-axis accelerometer, able to measure the instantaneous linear acceleration γ in three orthogonal directions. For each of its three axes, it has a high measurement dynamic limited by a high saturation threshold, for example equal to 200 g (γ₃ₛ=200 g), above the saturation threshold of the first accelerometer γ₂ₛ. The second accelerometer 3 comprises analog/digital conversion means configured for sampling the measurements at a high sampling frequency set at 1000 Hz.

Thus, the second accelerometer 3 is capable of measuring accelerations below 200 g, thus very substantially exceeding the saturation threshold of the first accelerometer 1 limited to 16 g. This is particularly advantageous to measure very high accelerations which the first accelerometer 2 would be incapable of measuring, in the swing movement of the player.

Care will be taken that the second accelerometer 3 is configured to measure the acceleration γ at a cadence at least 2 times greater than that of the first accelerometer 2. This is particularly advantageous in particular, in the case of a swing movement, to identify with accuracy the maximum angular speed on the basis of the values of linear acceleration measured in non-saturated regime by the second accelerometer 3.

The first accelerometer 2 is selected, such that it has a measurement resolution greater than that of the second accelerometer 3. By definition, the measurement resolution corresponds to the conversion resolution of the analog measurement into a digital value expressed in a number of bits.

In particular, the first accelerometer 2 is configured to supply high resolution measurements set for example at 32 bits but over a low dynamic limited to 16 g (γ₂ₛ<γ₃ₛ), while the second accelerometer 3 is configured to supply measurements of low resolution set for example at 16 bits but over a large dynamic limited to 200 g (γ₃ₛ>γ₂ₛ).

The second accelerometer 3 is provided to mitigate the limitations of the first accelerometer 1 and operate such that instantaneous linear acceleration values can be measured in a non-saturated regime, throughout the duration of the swing movement and in particular when the first accelerometer 2 is in saturation regime.

In other embodiments, a single linear accelerometer with a high measurement dynamic, such as the second accelerometer described above, could be used to measure the instantaneous acceleration γ in non-saturated regime, so as to provide, at each sampling instant, a non-saturated instantaneous linear acceleration value.

The device according to the invention further comprises computing means 40 configured to estimate in real time an angular speed ω above the saturation threshold of the gyroscope (2000°/s), according to an instantaneous linear acceleration value γ measured by the first accelerometer 2 or the second accelerometer 3 and according to at least one angular speed parameter measured by the gyroscope 1 or estimated by the computing means at the earlier instant

By way of illustrative and non-limiting example, the computing means 40 are comprised in a central processing unit 4, such as a micro-processor in particular of ARM (Cortex-M4) type.

The device according to the invention further comprises a random access memory 5a configured to store the values measured in real time by the measuring means, such as the gyroscope 1, the first accelerometer 2 and the second accelerometer 3. Preferably, the random access memory 5a is of FIFO (First In First Out) type, to enable the processor 4 to read, in a burst, the data obtained with the measuring means. The use of this memory is particularly advantageous to increase the rapidity of execution of the method according to the invention, by optimizing the time for obtaining information by the computing means 40. The device according to the invention further comprises a non-volatile memory 5b of ROM (Read Only Memory) type, configured to store a computer program configured to execute all or some of the steps of the method according to the invention.

The device according to the invention further comprises detection means 41 for detecting a saturation state of any one of the measuring means such as the gyroscope 1, the first accelerometer 2 or the second accelerometer 3. For example, these detection means 41 are configured to detect whether the values measured by any one of the measuring means attain their respective saturation threshold.

By way of illustrative and non-limiting example, these detection means 41 are implemented by the processor 4, which is configured to receive a saturation signal S₁₄, S₂₄, S₃₄ issued respectively by the gyroscope 1, the first accelerometer 2 and the second accelerometer 3, in case of saturation, to indicate to the processor that the data measured are no longer reliable. In the present example, the second accelerometer 3 has a saturation threshold equal to 200 g which is sufficiently high to avoid the latter entering a state of saturation, in a swing movement.

The device according to the invention further comprises calibration means 43 configured to calibrate the second accelerometer 3, according to the acceleration values γ measured by the first accelerometer 2, in case of detection of a state of saturation of the latter. These calibration means 43 are implemented by the processor 4.

The device further comprises a communication interface 6, preferably wireless, for example of Bluetooth® or Near Field Communication type, so as to communicate with a mobile terminal (not shown), on which is installed an application configured to display the sporting performance of the golfer, on the basis of information transmitted by said device.

In the present example embodiment, all the components of the device according to the invention, as described above, are integrated onto a same single-unit printed circuit of PCB (Printed Circuit Board) type. This circuit may itself be integrated into a multisport data sensor C, as illustrated in FIG. 2. For example, the device according to the invention 100 may be disposed in a central zone Z of the sensor.

In the context of the application concerned, the multisport data sensor C is fastened to the golfer's glove. By virtue of the device of the invention 100, the data sensor C can measure high angular speeds, beyond the limits imposed by the measuring capacities of the first accelerometer 2 and/or of the gyroscope 1. In particular, the sensor C is configured to determine reliably the maximum angular speed of the golf club head, in a swing movement, according to the steps of the method of the invention as described below.

FIG. 3 illustrates the main steps of the method according to an example embodiment of the invention, to determine high angular speeds, and in particular the maximum angular speed of the golfer's glove, on which is fastened the sensor C, in a swing movement. It will be possible to compute the rotational speed of the golf club and in particular its maximum rotational speed at each instant according to the angular speed measured or estimated according to the invention.

The method will also be described with reference to FIGS. 4a, 4b and 4c which represent, by way of illustrative example, the change over time of the quantities measured respectively by the first accelerometer 2, the gyroscope 1 and the second accelerometer 3.

In a first measuring step E₁, the gyroscope 1 measures, at each instant tₙ, an instantaneous angular speed ω, in a range of values below the saturation threshold ω₁ₛ of the gyroscope. The value measured at the instant tₙ by the gyroscope is denoted ω₁(n). An example of change over time of this measured quantity is illustrated in FIG. 4b.

In a second measuring step E₂, the first accelerometer 2 measures the linear acceleration γ at each instant tₙ. The value measured at the instant tₙ by the first accelerometer 2 is denoted γ₂(n). An example of change over time of this measured quantity γ₂(n) is illustrated in FIG. 4a.

In a third measuring step E₃, the second accelerometer 3 measures the linear acceleration γ at each instant tₙ. The value measured at the instant tₙ by the second accelerometer 3 is denoted γ₃(n). An example of change over time of this measured quantity γ₃(n) is illustrated in FIG. 4c.

The three measuring steps E₁, E₂ and E₃ are carried out in real time and simultaneously. Thus, the first 2 and second 3 accelerometers provide, at each instant tₙ, the linear acceleration values γ₂(n) and γ₃(n) respectively, at the second E₂ and third E₃ measuring steps, while the gyroscope 1 provides the instantaneous value of angular speed ω₁(n) at the first measuring step E₁.

At a saturation detecting step E₄, the processor 4 checks at each instant tₙ, whether a saturation signal has been issued by any one of the measuring means 1, 2, 3.

In case of detection of the saturation signal S₁₄ issued by the gyroscope 1 (sub-step E41), as soon as the value of the instantaneous angular speed ω₁(n) supplied by the gyroscope 1 reaches the saturation threshold ω₁ₛ, the processor 4 implements a computing step E5 to estimate the angular speed ω(n), at each instant tₙ.

At the instant of the saturation detection, the estimated value of the angular speed ω(n) is computed according to the instantaneous linear acceleration value γ₂(n) or γ₃(n) not saturated at the instant tₙ and according to the value of angular speed ω₁(n−1) measured by the gyroscope 1 at the instant preceding the detection of its saturation state, such that ω₁(n−1)<ω₁ₛ. Thus, at the instant of detecting a state of saturation of the gyroscope 1, at least one first measurement of the angular speed below said saturation threshold has been obtained, it being precisely this value measured in a non-saturated state which is used for the estimation of the angular speed.

For the instants following the entry into the state of saturation, the angular speed value ω(n) estimated at each instant tₙ, is computed according to the value of angular speed ω(n−1) estimated at the preceding instant tₙ₋₁, that is to say obtained further to the preceding iteration of the computing step. The computing step E₅ is reiterated so long as the gyroscope 1 is in state of saturation.

So long as the first accelerometer 2 is not saturated at the instant tₙ, the instantaneous linear acceleration value γ₂(n) measured by that accelerometer is used in the computing step E₅ for the estimation ω(n) at that instant tₙ.

In case of detection (sub-step E₄₂) of the saturation signal S₂₄ issued by the first accelerometer 2, the processor 4 implements a calibrating step E₆, at which the linear acceleration values γ₃(n) measured by the second accelerometer 3 are corrected according to the linear acceleration values γ₂(n) measured by the first accelerometer 2.

In case of detection (sub-step E₄₃) of the saturation signal S₃₄ issued by the second accelerometer 3, the processor 4 generates an indicator warning that the estimated value of angular speed is no longer reliable. It will be noted that in the case of the application concerned here, the saturation threshold of the second accelerometer 3 set at 200 g is sufficiently high to avoid reaching a saturation state on any one of its three measuring axes, throughout the duration of accomplishing the swing movement by the golfer.

In the example illustrated in FIGS. 4a, 4b, 4c, it is considered that the first accelerometer 2 reaches a state of saturation S₂ corresponding to the threshold γ₂ₛ=16 g at a first instant t₁, before the gyroscope 1 saturates. At the first instant t₁, the first accelerometer 2 enters the state of saturation S₂, and sends the saturation signal S₂₄ indicating its state of saturation to the processor 4 to inform that the acceleration measurement it has made at that instant is no longer reliable (γ₂₍₁₎=γ₂ₛ). It is assumed that the gyroscope 1 reaches a state of saturation S₁ corresponding to the threshold ω₁ₛ=2000°/s, at a later second instant t₂, such that t₂>t₁, so that ω₁(2)=ω₁ₛ.

According to another scenario, the gyroscope 1 saturates before the first accelerometer 2. In this case, the gyroscope 1 sends the saturation signal S₁₄ indicating its state of saturation S₁ to the processor 4, signifying that the value of angular speed measured at that instant is no longer reliable.

In case of saturation of the first accelerometer 2, the processor 4 calibrates (or regulates with a standard) the second accelerometer 3, in the calibrating step E₆, using all or some of the values of linear acceleration γ₂(n) measured by the first accelerometer 2 to adjust the linear acceleration values γ₃(n) measured by the second accelerometer 3. In the scenario of FIG. 4, it is considered that all the values measured are taken into account up until the first instant t₁, at which the first accelerometer 2 has entered into its state of saturation S₂. These values are stored in the FIFO memory 5a, in the form of a matrix of digital samples and are sent in a block or burst to the processor 4, as of the detection of the saturation at the first instant t₁.

More specifically, the calibrating step E₆ consists of correcting the acceleration values γ₃(n) measured by the second accelerometer 3 according to those measured γ₂(n) by the first accelerometer 2 in a non-saturated regime. This calibrating step is particularly advantageous if the first accelerometer 2 has an analog/digital conversion resolution greater than that of the second accelerometer 3.

On the basis of the values of acceleration measured in real time by the second accelerometer 3, the processor 4 computes a series of angular speed values ω(n) at successive instants tₙ, as of detection of the saturation of the gyroscope 1 at the instant t₂.

At an analyzing step E₇, the processor 4 determines a maximum angular speed ωₚ from among the series of angular speed values ω(n) estimated in multiple iterations of the computing step E₅.

For example, it is assumed that the maximum acceleration measured by the second accelerometer 2 is equal to 40 g, this being identified in FIG. 4c by the point P, corresponding to a maximum extremum on the curve of the measured values. The search for this extremum is carried out with reliability according to classical digital analysis methods implemented by the processor 4.

Advantageously, the second accelerometer 3 has a sampling frequency of 1000 Hz. This frequency, being at least 2 times greater than the sampling frequency of the first accelerometer 2, is sufficiently high to accurately determine the maximum extremum P.

Test results have shown that rotational speeds attaining 3000°/s have been correctly estimated according to the present invention.

FIG. 5 illustrates the main steps of the method for estimating the angular speed according to a first embodiment of the invention.

This particular embodiment uses the linear acceleration values as measured by one of the two accelerometer in a non-saturated state (γ₂(n)<γ₂s or γ₃(n)<γ₃s) and angular speed values obtained at earlier instants, these values being corrected by means of parameters or coefficients determined in advance using statistical methods.

At a conversion step E₅₃, the instantaneous linear acceleration measured in a non-saturated regime by one of the two accelerometers, is converted at each instant tₙ, into a component of angular speed A(n), by multiplication of a conversion coefficient C₁ expressed in s.m⁻¹.

This angular speed component A(n) is added to the preceding value of the angular speed ω(n−1), estimated further to a preceding iteration of the computing step E₅₅.

Advantageously and optionally, the conversion coefficient C₁ is a parameter determined statistically, based on several real cases having saturation of the gyroscope 1.

The value of this parameter C₁ may be constructed by applying known statistical analysis methods. It may, in particular, be a method consisting of seeking the values of the parameter which make it possible to retrieve the true acceleration values which are known for each of these cases. For the application concerned, the different cases correspond to swing movements of a golfer for which saturation is observed.

Advantageously and optionally, the value of the angular speed ω(n) estimated at the instant tₙ depends on a differential Δ between two values of angular speed estimated in advance, such that Δ=ω(n−1)−ω(n−2).

At a correction step E₅₄, this differential Δ is multiplied by an attenuation coefficient C₂ provided to limit the increase in the value of the estimated angular speed. This attenuation coefficient C₂ is obtained in advance by a statistical analysis method. The value of this coefficient as supplied by the statistical analysis is less than 1.

The fact of determining the value of the conversion coefficient C₁ and/or the value of the attenuation coefficient C₂ by a statistical analysis method is particularly advantageous to obtain a reliable value, taking into account a sufficiently wide diversity of cases and variation of parameters such as the height of the golfer or the swing technique.

At the computing step E₅₅, the angular speed ω(n) estimated at the instant tₙ is computed according to the following expression: ω(n)=ω(n−1)+A(n)+C₂.Δ in which A(n) depends on C₁.γ(n).

In this case, the angular acceleration corresponding to the derivative of the angular speed relative to time is considered constant, and in particular zero.

Thus, the angular speed ω is computed according to values of linear acceleration measured in real time and values of angular speed estimated at earlier instants (i.e. in preceding iterations of the computing step E₅₅).

FIG. 6 illustrates the main steps of the method for estimating the angular speed according to a second embodiment of the invention.

This particular embodiment exploits the values of linear acceleration measured in real time and values of angular speed obtained at earlier instants to determine a radius R that is characteristic of the rotational movement, the value of this radius itself being used to estimate the angular speed when the gyroscope 1 is in a state of saturation.

In the case of a perfect rotational movement, the radius R is a fixed geometric parameter. However, in practice, the value of this radius is not necessarily constant, in particular such as in the case of the application concerned, in which the swing movement does not match a perfect rotation of the golf club, in certain phases of the movement.

According to this second embodiment, the computing step includes a sub-step E₅₀ of evaluating the radius R of a path that is characteristic of a rotational movement, according to the non-saturated value of linear acceleration measured and according to the value of angular speed ω₁(n) measured if the gyroscope 1 is not in a state of saturation.

Thus, the invention makes it possible to reliably compute, in a swing movement, the instantaneous value of the radius R of rotation. The implementation of this real time computation is particularly advantageous given that the radius of the path followed by the golf club is not in reality perfectly constant over time, it being possible for this radius to vary during certain phases of the movement but remain relatively stable in other phases, when there is truly a rotation.

According to a particularity of the invention, the value of the radius R is computed at each instant tₙ (sub-step E₅₀), according to the following expression [1]:

$${R}_{( n )} = \frac{{γ}_{( n )}}{\sqrt{{\dot{ω}}^{2} ( n ) + {ω}^{4} ( n )}}$$

in which γ(n) designates the value of the linear acceleration measured at the instant tₙ: γ₂(n) or γ₃(n) supplied respectively by the first accelerometer 2 or the second 3 accelerometer according to their state of saturation; and ω(n) et \dot{ω}(n) respectively designate the angular speed and the angular acceleration measured by the gyroscope 1 at the instant tₙ in a non-saturated measuring regime.

In the context of the application concerned, expression [1] assumes that the golf club is not deformable and that the movement of the club is locally assimilated to a rotational movement around a fixed axis.

The angular acceleration \dot{ω}(n) is preferably measured at each instant tₙ by the gyroscope 1. However, if the gyroscope 1 is not able to measure these values, they are computed from values of angular speed measured in advance by the gyroscope 1.

In the absence of saturation of the gyroscope, this angular acceleration \dot{ω}(n) may be computed according to at least one value of angular speed measured at an instant earlier than the instant of detection of saturation of the gyroscope. In particular, the angular acceleration at the instant tₙ is computed according to the following expression:

\dot{ω}(n)=[ω(n)−ω(n−1)]/T

in which ω(n) and ω(n−1) designate the angular acceleration measured by the gyroscope 1 respectively at the instants tₙ and tₙ₋₁, T designating the reference time interval between two consecutive instants tₙ₋₁−tₙ, matching the inverse of the sampling frequency.

To obtain a reliable value of the radius R at the instant tₙ, it is necessary to ensure that the accelerometer that provides the values of instantaneous linear acceleration and the gyroscope 1 are not saturated. This is the case, for example, for measurement points taken at an instant t<t₁, such as those identified by A and B, in FIGS. 4a and 4b respectively. The detection of a state of saturation of any one of the means is carried out as described above (step E4).

By default, the values of linear acceleration are supplied by the first accelerometer 2, but in case of saturation thereof, the values measured by the second accelerometer 3 are used, further to the calibrating step E₆, for the computation of R for the successive instants tₙ so as to obtain a series of reliable values of radius R(n).

At a stable phase of the swing movement corresponding to a rotation, it will be possible to determine an average value of the radius from a set of values of said series of values R(n). A confidence indicator for the radius R, such as a standard deviation value σ_{R} could also be determined based on the series of values R(n) so as to characterize the variations in the radius during different phases of the movement.

In particular, a value of the radius R may be computed reliably according to expression [1] above, before saturation of the gyroscope 1. As soon as the gyroscope 1 saturates, the value R(n) at each instant tₙ is approximated by the value R(n−1), as computed at the preceding instant tₙ₋₁.

The angular speed ω is estimated at each instant tₙ according to the radius value computed at the preceding instant tₙ₋₁ and according to the value of instantaneous linear acceleration provided by the first accelerometer 2 or the second accelerometer in a non-saturated regime at the instant tₙ. The estimation of the angular speed ω is carried out by the computing means 40 of the processor 4, at a computing sub-step E′₅₅ which will be described below in several variant embodiments.

The computation of the angular speed employed according to a first variant of the second embodiment is now described with reference to FIG. 7.

According to this variant embodiment, the angular speed ω(n) estimated at the instant tₙ is computed, in real time, at the sub-step E′₅₅, according to the following expression [2]:

$${ω}_{( n )} = {( \frac{{γ}_{( n )}^{2}}{{R}_{( n - 1 )}^{2}} - {\dot{ω}}_{( n - 1 )}^{2} )}^{1 / 4}$$

in which γ(n) designates the value of the linear acceleration measured at the instant tₙ, this value γ₂(n) or γ₃(n) being measured respectively by the first 2 or second 3 accelerometer according to their state of saturation; \dot{ω}(n−1) designates the angular acceleration estimated at the preceding instant tₙ₋₁; and R(n−1) designates the value of the radius computed at the preceding instant tₙ₋₁

Expression [2] is obtained by assuming that the variation in angular acceleration \dot{ω} and the variation in the radius R, between two consecutive instants tₙ, tₙ₋₁ are nil, such that \dot{ω}(n)=\dot{ω}(n−1) and R(n)=R(n−1).

The value of the radius R(n−1) at the preceding instant tₙ₋₁ is computed according to expression [1], the angular acceleration value \dot{ω}(n−1) at the preceding instant tₙ₋₁ being computed as described above.

In the scenario illustrated in FIG. 4, at the first instant t₁, only the first accelerometer 2 is saturated, such that the radius R(1) is computed at sub-step E₅₀ according to the value of linear acceleration γ₃(1) measured by the second accelerometer 3 at that instant t₁ and according to the value of angular speed ω(1) and the angular acceleration value \dot{ω}(1) at that same instant t₁, according to expression [1] as follows:

$${R}_{( 1 )} = \frac{{γ}_{3 ( 1 )}}{\sqrt{{\dot{ω}}_{( 1 )}^{2} + {ω}_{( 1 )}^{4}}}$$

As soon as a state of saturation S₁ of the gyroscope 1 is detected, for example at the second instant t₂ according to the scenario of FIG. 4, the value of the angular speed ω(2) at that instant t₂ is computed according to expression [2] in the sub-step E′₅₅ according to the value of the radius R(1) at the instant t₁ before saturation of the gyroscope 1, according to the linear acceleration value γ₃(2) measured at the instant t₂ by the second accelerometer 3, and according to the angular acceleration value \dot{ω}₁²(1) measured by the gyroscope 1 at the instant t₁, as follows:

$${ω}_{( 2 )} = {( \frac{{γ}_{3 ( 2 )}^{2}}{{R}_{( 1 )}^{2}} - {\dot{ω}}_{( 1 )}^{2} ( 1 ) )}^{1 / 4}$$

The angular acceleration \dot{ω}₁(1) is measured by the gyroscope 1 at the first instant t₁ in a non-saturated regime.

For the later instants and so long as the gyroscope 1 is in a saturated state, the values of angular speed ω(n) at each instant tₙ are computed according to the expression [2], the value of the radius R(n−1) at the preceding instant tₙ being estimated according to expression [1] as described above.

The computation of the angular speed ω employed according to a second variant of the second embodiment is now described with reference to FIG. 8.

According to this second variant, the value of angular speed ω(n) estimated at the instant tₙ is computed, at a sub-step E′₅₅, by solving the following 4th order equation [3], this value being a solution to the equation:

$${ω}_{( n )}^{4} + \frac{{ω}_{( n )}^{2}}{{T}^{2}} - 2 \frac{{ω}_{( n - 1 )}}{{T}^{2}} {ω}_{( n )} - \frac{{γ}_{( n )}^{2}}{{R}_{( n - 1 )}^{2}} + \frac{{ω}_{( n - 1 )}^{2}}{{T}^{2}} = 0 ,$$

in which γ(n) designates the value of linear acceleration measured in a non-saturated regime, it being possible for this to be supplied by the first 2 or the second 3 accelerator according to their state, ω(n−1) designates the value of angular speed obtained at the preceding instant tₙ₋₁, R(n−1) designates the radius value computed at the preceding instant tₙ₋₁, T designates the reference time interval between two consecutive instants tₙ−tₙ₋₁ corresponding to the inverse of the sampling frequency.

Equation [3] is obtained by assuming that the variation in the radius R between two consecutive instants tₙ and tₙ₋₁ is nil, such that R(n)=R(n−1) and by assuming that the angular acceleration \dot{ω}(n) is expressed according to the values of angular speed obtained at earlier instants. For example, the angular acceleration \dot{ω}(n) is computed in a sub-step E₅₂, according to the following expression:

\dot{ω}(n−1)=[ω(n−1)−ω(n−2)]/T,

in which T designates the duration between two consecutive sampling instants.

For example, the resolution of this 4^{th} order equation may be obtained by implementing the Ferrari method.

A bisection solving method may also be used by approximating the roots of the 4^{th} order equation as indicated below.

In the particular case in which the sampling of the measurements is carried out at a high frequency (corresponding to a small time interval T), it can be considered that the variation in the value of the angular speed estimated between two consecutive instants tₙ et tₙ₋₁ is nil, such that ω(n)⁴=ω(n−1)⁴. This approximation leads to solving the following 2^{th} order equation [4]:

$$ω ( n ) = ω ( n - 1 ) \pm T \cdot \sqrt{\frac{{γ}_{( n )}^{2}}{{R}_{( n - 1 )}^{2}} - {ω}_{( n - 1 )}^{4}}$$

Thus, the angular speed ω(n) is computed at each instant tₙ according to a value of the angular speed measured w₁(n−1) or estimated ω(n−1) at the preceding instant tₙ₋₁ and according to the value of the linear acceleration (γ₂(n) or γ₃(n)) measured at the instant tₙ. This 2^{nd} order equation is particularly advantageous for reducing the computing time for a given processor.

On the assumption that the angular acceleration is nil \dot{ω}(n)=0, the solutions to the 4^{th} order equations are given by the following expression [5]:

$$ω ( n ) = \frac{{γ}^{2} ( n )}{{R}_{( n - 1 )}^{2}}$$

If there is no solution to the above 4^{th} order equation [3], the processor 4 will be configured to determine the value of ω(n) that minimizes the following function ƒ(n) [6]:

$$f ( n ) = {ω}_{( n )}^{4} + \frac{{ω}_{( n )}^{2}}{{T}^{2}} - 2 \frac{{ω}_{( n - 1 )}}{{T}^{2}} {ω}_{( n )} - \frac{{γ}_{( n )}^{2}}{{R}_{( n - 1 )}^{2}} + \frac{{ω}_{( n - 1 )}^{2}}{{T}^{2}}$$

In this case, by considering that the terms of angular speed ω(n)² are negligible relative to the terms of angular acceleration \dot{ω}(n), the solutions are given by the following expression [7]:

$$ω ( n ) = ω ( n - 1 ) \pm T . \frac{γ ( n )}{R ( n - 1 )}$$

Thus, the angular speed ω(n) is computed at each instant tₙ according to the linear acceleration γ(n) measured by one of the two accelerometers in a non-saturated regime at the instant tₙ, and according to the value of angular speed ω(n−1) obtained at the earlier instant tₙ₋₁, and the value of the radius R(n−1) obtained at that same earlier instant t₋₁.

In the example of the scenario illustrated in FIG. 4, at the first instant t₁, the value of the radius R(1) is computed as previously according to the expression [1], this value being used as a parameter to solve the 4^{th} order equation.

By applying the preceding assumptions, the computation of the angular speed ω(n) may be simplified by replacing the step of solving this 4^{th} order equation, by the computation of ω(n) according to the above expression [7]. In this case, when the state of saturation of the gyroscope 1 is detected at the second instant t₂, the value of angular speed ω(2) estimated at that instant t₂ is such that:

$$ω ( 2 ) = ω ( 1 ) \pm T . \frac{{γ}_{3} ( 2 )}{R ( 1 )}$$

In the case of the application concerned, the angular speed of the golf club head V_{M} is determined according to the linear speed V_{A} of the grip zone of the club at which is placed the sensor C, according to the rotational speed of the club corresponding to the instantaneous angular speed ω estimated according to the invention, and the length L of the golf club between the sensor C and the head of the club, according to the following expression [8]:

V_{M}=V_{A}+ω.L.

This expression [8] is valid, in particular, if the swing movement is well executed, that is to say if the vectors \vec{V_{A}} and \vec{ω}∧\vec{L} are co-linear and oriented in the same direction, the symbol ∧ designating the vector product operand.

The steps of detecting E₄, calibrating E₆, computing E₅ and analyzing E₇ implemented by the processor 4 are determined by instructions of a computer program.

The executable code of this program may be stored in the non-volatile memory 5b, on a storage medium or on a removable digital medium, for example such as a disk or a memory card. According to a variant, the executable code of this program may be received by means of a communication network, via the network interface 6, in order to be stored in one of the storage means of the device, such as the RAM (Random Access Memory) 5, before being executed.

Therefore, the invention is also directed to a computer program on a data carrier, that program being capable of being implemented by a microprocessor, that program comprising instructions configured for the implementation of the steps of the method as mentioned above.

The processor 4 is configured to control and direct the execution of the instructions or portions of software code of the program or programs according to one of the embodiments of the invention, which instructions are stored in one of the aforementioned storage means. After powering up, the processor 4 is capable of executing instructions stored in the main RAM, relative to a software application, after those instructions have been loaded from the ROM for example. Such software, when executed by the processor 4, gives rise to the steps of computing E₅, detecting E₄, calibrating E₆ and analyzing E₇ as illustrated and described with reference to FIG. 3.

In this embodiment, the device according to the invention is a programmable apparatus which uses software to implement the invention. However, on a subsidiary basis, the present invention may be implemented in the hardware (for example in the form of an application specific integrated circuit or ASIC).

Naturally, to satisfy specific needs, the skilled person will be able to apply modifications to the preceding description.

Although the present invention has been described above with reference to specific embodiments, the present invention is not limited to those embodiments alone. Any modification within the field of application of the present invention will be obvious for the person skilled in the art.

1. A method for estimating a series of angular speeds ωₙ at successive instants tₙ, by a device for estimating a series of angular speeds, characterized in that it comprises:
a first measuring step (E₁), by first measuring means (1), of an angular speed in a range of values below a saturation threshold ω₁ₛ;
a second measuring step (E₂; E₃), by second measuring means (2, 3), of a linear acceleration γ;
a detecting step (E₄₁), by computing means (40), of a state of saturation at said first measuring step (E₁);
a computing step (E₅), by computing means (40), to estimate, in case of detection of measurement saturation at said first measuring step (E₁), said angular speed ω(n), at each instant tₙ, according to at least one value of said acceleration (γ₂(n); γ₃(n)) measured at the instant tₙ (E₂; E₃) and according the value of angular speed (ω(n−1); ω₁(n−1)) obtained least at at one earlier instant tₙ₋₁, at least one first measurement of the angular speed below said saturation threshold ω₁ₛ having been obtained.

2. A method according to claim 1, characterized in that the angular speed ω(n) estimated at the instant tₙ is obtained (E₅₅) by adding, to the value of the angular speed ω(n−1) obtained at the preceding instant tₙ₋₁, a component of angular speed A(n) obtained at the instant tₙ by conversion (E₅₃) of the value of linear acceleration (γ₂(n); γ₃(n)) measured in a non-saturated regime at that same instant tₙ, by applying a predetermined conversion coefficient (C₁).

3. A method according to claim 2, characterized in that the angular speed ω(n) estimated at the instant tₙ is obtained (E₅₅) by adding, to the value of the angular speed ω(n−1) obtained at the preceding instant tₙ₋₁, a differential Δ(n) at the instant tₙ of which the value is obtained by correction (E₅₄) of the difference (ω(n−1)−ω(n−2)) between two values of angular speed obtained at two consecutive earlier instants tₙ₋₂, tₙ₋₁, by applying a predetermined attenuation coefficient (C₂).

4. A method according to claim 3, characterized in that at least one of the conversion (C₁) and attenuation (C₂) coefficients is obtained in advance by a method of statistical analysis.

5. A method according to claim 1, characterized in that said computing step (E₅) includes a sub-step (E₅₀) of evaluating a radius R of a path of a rotational movement, according to said value of linear acceleration (γ₂(n); γ₃(n)) and the value of angular speed measured ω₁(n−1) or estimated ω(n−1) further to a preceding iteration of the computing step (E₅), and in that said value of angular speed ω(n) at the instant tₙ is computed (E′₅₅) according to the value of said radius R obtained at the preceding instant tₙ₋₁.

6. A method according to claim 5, characterized in that the value of the radius R is computed at the instant tₙ according to the following expression:
$${R}_{( n )} = \frac{{γ}_{( n )}}{\sqrt{{ω}^{2} ( n ) + {ω}^{4} ( n )}}$$
in which γ(n), ω(n) and \dot{ω}(n) respectively designate the linear acceleration, the angular speed and the angular acceleration, at the instant tₙ.

7. A method according to claim 6, characterized in that the angular speed estimated at the instant tₙ is computed according to the following expression:
$${ω}_{( n )} = {( \frac{{γ}_{( n )}^{2}}{{R}_{( n - 1 )}^{2}} - {\dot{ω}}_{( n - 1 )}^{2} )}^{1 / 4}$$

8. A method according to claim 6, characterized in that said value of angular speed ω(n) estimated at the instant tₙ is computed by solving the following equation:
$${ω}_{( n )}^{4} + \frac{{ω}_{( n )}^{2}}{{T}^{2}} - 2 \frac{{ω}_{( n - 1 )}}{{T}^{2}} {ω}_{( n )} - \frac{{γ}_{( n )}^{2}}{{R}_{( n - 1 )}^{2}} + \frac{{ω}_{( n - 1 )}^{2}}{{T}^{2}} = 0 ,$$
T designating a reference time interval between two consecutive instants.

9. A method according to claim 8, characterized in that said value of angular speed ω(n) is computed according to the following expression:
$$ω ( n ) = ω ( n - 1 ) \pm T . \frac{γ ( n )}{R ( n - 1 )}$$

10. A method according to claim 1, characterized in that the value of linear acceleration γ is obtained with a second accelerometer (3) in case of saturation of a first accelerometer (2) and in that said method further comprises a calibrating step (E₆) for calibrating the second accelerometer (3) according to the values of acceleration measured by the first accelerometer (2) before saturation.

11. A device for estimating a series of angular speeds ωₙ at successive instants tₙ, said device being characterized in that it comprises:
first measuring means (1) configured for measuring an angular speed ω₁ in a range of values below a saturation threshold ω₁ₛ;
second measuring means (2, 3) configured for measuring a linear acceleration γ;
detecting means (41) for detecting a state of saturation at said first measuring means (1);
computing means (40) configured for estimating, in case of detection of saturation of said first measuring means (1), said angular speed ω(n), at each instant tₙ, according to at least one value of said linear acceleration (γ₂(n); γ₃(n)) measured at the instant tₙ, and according the value of angular speed (ω(n−1); ω₁(n−1)) obtained at an earlier instant tₙ₋₁, at least one first measurement of the angular speed below said saturation threshold ω₁ₛ having been obtained.

12. A device according to claim 11, characterized in that the first measuring means (2) comprise a gyrometer or a gyroscope (2) and in that the second measuring means comprise at least one linear accelerometer (2; 3; 2, 3).

13. A device according to claim 12, characterized in that the second measuring means comprise a first accelerometer (2) and a second accelerometer (3), said second accelerometer having a saturation threshold γ₃ₛ above that γ₂ₛ of said first accelerometer (2), and in that said computing means (40) are configured to obtain the value of linear acceleration γ₃(n) measured with said second accelerometer (3) in case of saturation of the first accelerometer (2).

14. A device according to claim 13, characterized in that it further comprises calibration means (43) configured to calibrate the second accelerometer (3) according to a set of acceleration values measured by the first accelerometer (2) in a non-saturated measuring regime.

15. A device according to claim 13, characterized in that the second accelerometer (3) is configured to measure the acceleration at a cadence at least 2 times greater than that of the first accelerometer (2).

16. A data sensor (C), characterized in that it comprises a device according to claim 11.

17. A computer program comprising instructions configured for carrying out at least any one of the detecting (E₄), calibrating (E₆), computing (E₅), and analyzing (E₇) steps of the method according to claim 1, when said program is executed on a computer.

18. An information storage means, removable or not, partially or totally readable by a computer or a microprocessor containing code instructions of a computer program for executing at least any one of the detecting (E4), calibrating (E6), computing (E5), and analyzing (E7) steps of the method according to claim 1.
